(19) United States
(12) Patent Application Publication
(10) Pub. No.: US 2025/0084263 A1
(43) Pub. Date: Mar. 13, 2025

(54) INK FOR FORMING COATING FILM OF OPTICAL MEMBER, AND OPTICAL MEMBER

(71) Applicant: FUJIFILM CORPORATION, Tokyo (JP)

(72) Inventor: Goroh TAKADA, Saitama-shi (JP)

(21) Appl. No.: 18/822,305

(22) Filed: Sep. 2, 2024

(30) Foreign Application Priority Data
Sep. 12, 2023 (JP) 2023-147961
Aug. 7, 2024 (JP) 2024-131233

(51) Int. Cl. C09D 11/037; G02B 1/11

(52) U.S. Cl. CPC C09D 11/037; G02B 1/11

(57) ABSTRACT

Provided are an ink for forming a coating film of an optical member, containing a black pigment, at least one of a colored pigment or a colorless pigment, a binder, and a volatile component, in which, in a case of forming a coating film of an optical member, an average refractive index n of the coating film of an optical member in a wavelength range of 400 nm to 700 nm is 1.70 or more, and an average attenuation coefficient k of the coating film of an optical member in the wavelength range of 400 nm to 700 nm is 0.10 to 0.15, and a total ratio of the black pigment, the colored pigment, and the colorless pigment in an entire volume of the coating film of an optical member is 10% by volume to 40% by volume; and an application thereof.

### CROSS-REFERENCE TO RELATED APPLICATIONS

This application claims priority from Japanese Patent Application No. 2023-147961, filed on Sep. 12, 2023, and Japanese Patent Application No. 2024-131233, filed on Aug. 7, 2024, the entire disclosures of which are incorporated herein by reference in their entirety.

### BACKGROUND OF THE INVENTION

### 1. Field of the Invention

The present disclosure relates to an ink for forming a coating film of an optical member, and an optical member.

### 2. Description of the Related Art

In the related art, in order to suppress an inner surface reflection of an optical member such as a lens, a coating material is applied onto a part of the optical member to form a coating film (for example, referred to as “sanitizing” in some cases).

For example, JP1982-8264A (JP-S57-8264A) discloses a coating material for an inner surface reflection prevention of an optical member, which has a refractive index higher than a refractive index of an optical member such as a lens and a prism and contains a metal oxide having a high blackness as a main pigment.

In addition, JP2012-149197A discloses the following black coating material for an inner surface reflection prevention of an optical element, which has a sufficient effect of preventing an inner surface reflection for an optical element having a high refractive index and can ensure coating film workability even in a case where the coating material is stored for a long period.

The black coating material for an inner surface reflection prevention of an optical element, which is disclosed in JP2012-149197A, contains at least titanium dioxide, carbon black, a binder resin, a dispersant, and a solvent,
in which the titanium dioxide has a methanol hydrophobicity of 30% or more and 80% or less, a pH of 3.0 or more and 8.0 or less, and a content of 35% by mass or more and 75% by mass or less with respect to the solid content of the black coating material for an inner surface reflection prevention of an optical element,
the carbon black has a volatile content of 0.6% by mass or more and 6.0% by mass or less, a pH of 3.0 or more and 8.0 or less, and a content of 2% by mass or more and 20% by mass or less with respect to the solid content of the black coating material for an inner surface reflection prevention of an optical element,
the dispersant is a combination of a phthalocyanine compound and a polymer-based dispersant,
the phthalocyanine compound has a content of 1% by mass or more and 20% by mass or less with respect to 100% by mass of the carbon black, and
the polymer dispersant has an amine value of 5 mgKOH/g or more and 100 mgKOH/g or less and a content of 5% by mass or more and 40% by mass or less in a case where the total of the titanium dioxide and the carbon black is set to 100% by mass.

### SUMMARY OF THE INVENTION

In recent years, miniaturization and/or weight reduction of an optical member product incorporating an optical member (for example, a lens, a prism, and a waveguide) have been accelerated.

As one of methods for the miniaturization and/or weight reduction of the optical member product, there is a method of using a high-refractive-index optical member (for example, an optical member having a refractive index of 1.60 or more). With the high-refractive-index optical member, an optical path can be bent to a large extent even in a case of a small curvature. As a result, it is possible to reduce the thickness of the optical member and the number of sheets of the optical member included in the entire optical member product.

However, in a case where the refractive index of the optical member is increased and an angle at which the optical path is bent is increased, a deviation amount of a condensing position with respect to a deviation amount of an assembling position of the optical member is increased, and as a result, there is a tendency that image quality is likely to be deteriorated.

In this regard, an outer peripheral surface of the optical member serves as a position reference of the optical member in a case where the optical member is incorporated into a mirror frame. Therefore, variation in film thickness of a coating film of an optical member, provided on the outer peripheral surface of the optical member, affects positioning accuracy of the optical member in a case where the optical member is incorporated into the mirror frame.

In order to suppress the variation in film thickness of the coating film of an optical member, it is effective to increase light shielding properties of the coating film of an optical member to reduce the film thickness of the coating film of an optical member and to reduce the influence of the variation in film thickness of the coating film of an optical member on the positioning accuracy of the optical member.

As described above, from the viewpoint of improving the positioning accuracy of the optical member in a case where the optical member is incorporated into the mirror frame, it may be desired to improve the light shielding properties of the coating film of an optical member, provided on the optical member.

On the other hand, it may be desired to further improve a performance of suppressing the inner surface reflection (hereinafter, also referred to as inner surface reflection suppression property) in the optical member and a film quality (for example, adhesiveness, solvent resistance, and the like) with respect to the coating film of an optical member.

In addition, from the viewpoint of the inner surface reflection suppression property of the coating film of an optical member, it is desirable that, in principle of optics, a refractive index of a base material of an optical member (for example, a lens) and a refractive index of the coating film of an optical member, provided on a part of the base material of an optical member, are set to be as close as possible (ideally, the same value).

Therefore, in a case of increasing the refractive index of the base material of an optical member, it is desirable to increase the refractive index of the coating film of an optical member.

The present disclosure has been made in view of the above circumstances.

An object to be achieved by an embodiment of the present disclosure is to provide an ink for forming a coating film of an optical member, with which a coating film of an optical member having excellent light shielding properties, excellent inner surface reflection suppression property, excellent refractive index, and excellent film quality can be formed; and an optical member including the coating film of an optical member.

The present disclosure includes the following aspects.
<1> An ink for forming a coating film of an optical member, comprising:
a black pigment;
at least one of a colored pigment or a colorless pigment;
a binder; and
a volatile component,
in which, in a case of forming a coating film of an optical member, an average refractive index n of the coating film of an optical member in a wavelength range of 400 nm to 700 nm is 1.60 or more, and an average attenuation coefficient k of the coating film of an optical member in the wavelength range of 400 nm to 700 nm is 0.10 to 0.15, and
a total volume ratio of the black pigment, the colored pigment, and the colorless pigment in an entire volume of the coating film of an optical member is 10% by volume to 40% by volume.
<2> The ink for forming a coating film of an optical member according to <1>,
in which the average refractive index n of the coating film of an optical member in the wavelength range of 400 nm to 700 nm is 1.70 to 1.85.
<3> The ink for forming a coating film of an optical member according to <1> or <2>,
in which, with regard to each of the black pigment, the colored pigment, and the colorless pigment, the average refractive index n in the wavelength range of 400 nm to 700 nm is 2.00 or more, and
with regard to each of the black pigment and the colored pigment, the average attenuation coefficient k is 0.10 or more.
<4> An ink for forming a coating film of an optical member, comprising:
a black pigment;
at least one of a colored pigment or a colorless pigment;
a binder; and
a volatile component,
in which, with regard to each of the black pigment, the colored pigment, and the colorless pigment, an average refractive index n in a wavelength range of 400 nm to 700 nm is 2.00 or more,
with regard to each of the black pigment and the colored pigment, an average attenuation coefficient k is 0.10 or more, and
a total mass ratio of the black pigment, the colored pigment, and the colorless pigment in a total solid content is 6.5% by mass to 25.8% by mass.
<5> The ink for forming a coating film of an optical member according to any one of <1> to <4>,
in which the black pigment includes at least one selected from the group consisting of carbon black and titanium carbide,
the colored pigment includes at least one selected from the group consisting of iron oxide (III), silicon carbide, and copper oxide (I), and
the colorless pigment includes at least one selected from the group consisting of titanium oxide, diamond, zirconia, and indium tin oxide.
<6> The ink for forming a coating film of an optical member according to any one of <1> to <5>,
in which a median diameter of the pigments is 100 nm or less.
<7> The ink for forming a coating film of an optical member according to any one of <1> to <6>,
in which the binder contains an epoxy resin in which the average refractive index n in the wavelength range of 400 nm to 700 nm is 1.60 or more.
<8> The ink for forming a coating film of an optical member according to <7>,
in which the epoxy resin includes a fluorene-based epoxy resin.
<9> The ink for forming a coating film of an optical member according to <7> or <8>,
in which the epoxy resin includes a thermosetting type epoxy resin.
<10> The ink for forming a coating film of an optical member according to <9>, further comprising:
a thiol-based curing agent as a curing agent for an epoxy resin; and
a tertiary amine as a curing accelerator.
<11> The ink for forming a coating film of an optical member according to any one of <1> to <10>,
in which a content of the volatile component is 50% by mass or more with respect to a total amount of the ink for forming a coating film of an optical member.
<12> The ink for forming a coating film of an optical member according to any one of <1> to <11>,
in which the volatile component includes an organic solvent having a boiling point of 180° C. or lower.
<13> The ink for forming a coating film of an optical member according to any one of <1> to <12>,
in which the volatile component includes at least one selected from the group consisting of propyl acetate, propylene glycol monomethyl ether acetate, propylene glycol monomethyl ether, toluene, cyclohexane, and ethylene glycol monobutyl ether.
<14> The ink for forming a coating film of an optical member according to any one of <1> to <13> further comprising a silane coupling agent.
<15> The ink for forming a coating film of an optical member according to any one of <1> to <14>, further comprising a filler.
<16> An optical member comprising:
a base material of an optical member; and
a coating film of an optical member, provided on a part of the base material of an optical member,
in which the coating film of an optical member contains a black pigment and at least one of a colored pigment or a colorless pigment,
an average refractive index n of the coating film of an optical member in a wavelength range of 400 nm to 700 nm is 1.70 or more, and an average attenuation coefficient k of the coating film of an optical member in the wavelength range of 400 nm to 700 nm is 0.10 to 0.15, and
a total ratio of the black pigment, the colored pigment, and the colorless pigment in an entire volume of the coating film of an optical member is 10% by volume to 40% by volume.
<17> The optical member according to <16>,
in which the optical member is an optical member for broadcasting, an optical member for cinema, an optical member for a digital camera, an optical member for an industrial camera, an optical member for a projector, an optical member for a vehicle-mounted camera, an optical member for a smartphone-mounted camera, an optical member using a prism, or an optical member using an optical waveguide.

According to the embodiment of the present disclosure, there are provided an ink for forming a coating film of an optical member, with which a coating film of an optical member having excellent light shielding properties, excellent inner surface reflection suppression property, excellent refractive index, and excellent film quality can be formed; and an optical member including the coating film of an optical member.

### DESCRIPTION OF THE PREFERRED EMBODIMENTS

In the present specification, the numerical ranges shown using “to” means ranges including the numerical values described before and after “to” as the minimum value and the maximum value.

In a numerical range described in a stepwise manner in the present specification, an upper limit value or a lower limit value described in a certain numerical range may be replaced with an upper limit value or a lower limit value in another numerical range described in a stepwise manner. In addition, in the numerical range described in the present specification, an upper limit value and a lower limit value described in a certain numerical range may be replaced with values shown in Examples.

In the present specification, in a case where a plurality of substances corresponding to each component in a composition is present, the amount of each component in the composition means the total amount of the plurality of substances present in the composition, unless otherwise specified.

In the present specification, a combination of two or more preferred aspects is a more preferred aspect.

In the present specification, the meaning of the term “step” includes not only an independent step but also a step whose intended purpose is achieved even in a case where the step is not clearly distinguished from other steps.

### Ink for Forming Coating Film of Optical Member

Hereinafter, the ink for forming a coating film of an optical member (hereinafter, also simply referred to as “ink”) according to the first aspect and the second aspect of the present disclosure will be described.

The first aspect and the second aspect may have overlapping parts. That is, the ink according to the first aspect may have features of the ink according to the second aspect. First Aspect

The ink according to the first aspect is an ink for forming a coating film of an optical member, containing a black pigment, at least one of a colored pigment or a colorless pigment, a binder, and a volatile component, in which, in a case of forming a coating film of an optical member (hereinafter, also simply referred to as “coating film”), an average refractive index n of the coating film of an optical member in a wavelength range of 400 nm to 700 nm is 1.60 or more, and an average attenuation coefficient k of the coating film of an optical member in the wavelength range of 400 nm to 700 nm is 0.10 to 0.15, and a total volume ratio of the black pigment, the colored pigment, and the colorless pigment in an entire volume of the coating film of an optical member is 10% by volume to 40% by volume.

With the ink according to the first aspect, it is possible to form a coating film of an optical member, having excellent light shielding properties, excellent inner surface reflection suppression property, excellent refractive index, and excellent film quality.

The effect of the light shielding properties is an effect obtained by the fact that the total ratio of the black pigment, the colored pigment, and the colorless pigment in the entire volume of the coating film is 10% by volume or more and the average attenuation coefficient k is 0.10 or more. With the ink according to the first aspect, since a coating film of an optical member, having excellent light shielding properties, can be formed, a film thickness of the coating film of an optical member can be reduced and variation in film thickness can be reduced. As a result, positioning accuracy of the optical member in a case of incorporating the optical member into a mirror frame can be improved.

The effect of the inner surface reflection suppression property is an effect obtained by the fact that the average refractive index n is 1.60 or more and the average attenuation coefficient k is 0.15 or less.

The effect of the refractive index is an effect obtained by the fact that the average refractive index n is 1.60 or more.

The effect of the film quality is obtained by the fact that the total ratio of the black pigment, the colored pigment, and the colorless pigment in the entire volume of the coating film is 40% by volume or less.

The coating film of each of Examples had an average refractive index n of 1.60 or more and an average attenuation coefficient k of 0.15 or less, and thus had excellent inner surface reflection suppression property (that is, performance of suppressing an inner surface reflection in the optical member).

The coating film of each of Examples had an average attenuation coefficient k of 0.10 or more, and thus had excellent light shielding properties. As a result, since the coating film of an optical member could be formed with a thin film thickness, the variation in film thickness can be reduced, and as a result, the positioning accuracy of the optical member in a case of incorporating the optical member into the mirror frame can be improved.

In the coating film of each of Examples, the total ratio of the black pigment, the colored pigment, and the colorless pigment in the entire volume of the coating film was 10% by volume or more, and thus the light shielding properties were excellent (that is, it was possible to achieve the average attenuation coefficient k to be 0.10 or more; see Tables 1 to 3).

In the coating film of each of Examples, the total ratio of the black pigment, the colored pigment, and the colorless pigment in the entire volume of the coating film was 40% by volume or less, and thus the film quality (that is, adhesiveness and solvent resistance) was excellent (see Tables 1 to 3).

Hereinafter, the ink according to the first aspect will be described in more detail.

### Average Refractive Index n of Coating Film of Optical Member

In a case of forming a coating film of an optical member using the ink according to the first aspect, the average refractive index n of the coating film of an optical member in a wavelength range of 400 nm to 700 nm is 1.60 or more.

The fact that the average refractive index n of the coating film of an optical member is 1.60 or more contributes to the improvement of the inner surface reflection suppression property of the coating film of an optical member (that is, the performance of suppressing the inner surface reflection in the optical member).

From the viewpoint of further improving the inner surface reflection suppression property of the coating film, the average refractive index n of the coating film is preferably 1.70 or more.

On the other hand, from the viewpoint of further improving the inner surface reflection suppression property of the coating film, the average refractive index n of the coating film is preferably 1.90 or less, and more preferably 1.85 or less.

In the present disclosure, the expression “in a case of forming a coating film of an optical member” using the ink means that the ink is applied, and then heated and dried to form a coating film.

In the present disclosure, all of the average refractive index n, the average attenuation coefficient k, and the total volume ratio of the black pigment, the colored pigment, and the colorless pigment in the entire volume of the coating film of an optical member mean values measured using a coating film formed under conditions of a coating amount of 0.02 g/m² heating and drying conditions of 70° C. x 2 hours, and a film thickness of 20 μm.

Examples of a preferred range of the average refractive index n include a range of 1.60 to 1.90 and a range of 1.70 to 1.85.

The average refractive index n of the coating film of an optical member in the wavelength range of 400 nm to 700 nm is measured by the following method.

A spectroscopic ellipsometer (for example, a high-speed spectroscopic ellipsometer M-2000 manufactured by J.A. Woollam Japan.) is used for measuring a refractive index of the coating film of an optical member in the wavelength range of 400 nm to 700 nm in increments of 10 nm, and an arithmetic average value of the measured values of the refractive index is defined as the average refractive index n.

### Average Attenuation Coefficient k of Coating Film of Optical Member

In a case of forming a coating film of an optical member using the ink according to the first aspect, the average attenuation coefficient k of the coating film of an optical member is 0.10 to 0.15.

The fact that the average attenuation coefficient k is 0.10 or more contributes to the effect of the light shielding properties of the coating film of an optical member. As a result, the variation in film thickness can be suppressed because the film thickness of the coating film of an optical member can be thin, and as a result, the positioning accuracy in a case of incorporating the optical member into an optical member product can be improved.

From the viewpoint of further improving the light shielding properties of the coating film of an optical member, the average attenuation coefficient k is preferably 0.11 or more.

The fact that the average attenuation coefficient k is 0.15 or less contributes to the improvement of the inner surface reflection suppression property of the coating film of an optical member (that is, the performance of suppressing the inner surface reflection in the optical member).

From the viewpoint of further improving the inner surface reflection suppression property of the coating film of an optical member, the average attenuation coefficient k is preferably 0.14 or less, and more preferably 0.13 or less.

The average attenuation coefficient of the coating film of an optical member in the wavelength range of 400 nm to 700 nm is measured by the following method.

In the measurement of the refractive index for obtaining the above-described average refractive index n, data analysis is performed on the coating film of an optical member as a Cauchy model to obtain the attenuation coefficient of the coating film of an optical member in the wavelength range of 400 nm to 700 nm in increments of 10 nm. An arithmetic average value of the obtained attenuation coefficients is defined as the average attenuation coefficient k.

### Total Volume Ratio of Black Pigment, Colored Pigment, and Colorless Pigment in Entire Volume of Coating Film of Optical Member

In a case of forming a coating film of an optical member using the ink according to the first aspect, the total volume ratio of the black pigment, the colored pigment, and the colorless pigment in the entire volume of the coating film of an optical member is 10% by volume to 40% by volume.

The fact that the above-described volume ratio is 10% by volume or more contributes to the improvement of the light shielding properties of the coating film (specifically, to the achievement that the average attenuation coefficient k of the coating film is 0.10 or more).

The fact that the above-described volume ratio is 40% by volume or less contributes to the improvement of the film quality (for example, adhesiveness and solvent resistance) of the coating film.

From the viewpoint of further improving the film quality of the coating film, the above-described volume ratio is preferably 35% by volume or less, more preferably 30% by volume or less, and still more preferably 20% by volume or less.

The total volume ratio of the black pigment, the colored pigment, and the colorless pigment in the entire volume of the coating film of an optical member is obtained based on the entire volume of the ink coating film, and a density of each pigment.

The same applies to the content of each pigment, which will be described later.

A volume ratio of the black pigment in the entire volume of the coating film of an optical member is preferably 2% by volume to 20% by volume, more preferably 3% by volume to 15% by volume, and still more preferably 5% by volume to 10% by volume.

A volume ratio of the pigment other than the black pigment (that is, the colored pigment and the colorless pigment; the same applies hereinafter) in the entire volume of the coating film of an optical member is preferably 1% by volume to 31% by volume, more preferably 1% by volume to 10% by volume, and still more preferably 1% by volume to 5% by volume.

A volume proportion of the black pigment with respect to the total of the black pigment, the colored pigment, and the colorless pigment in the coating film of an optical member is preferably 20% by volume to 95% by volume, more preferably 40% by volume to 95% by volume, still more preferably 50% by volume to 95% by volume, and even more preferably 60% by volume to 90% by volume.

In the ink according to the first aspect, the preferred range of the volume proportion of the black pigment with respect to the total of the black pigment, the colored pigment, and the colorless pigment is the same as the preferred range of the volume proportion of the black pigment with respect to the total of the black pigment, the colored pigment, and the colorless pigment in the above-described coating film of an optical member.

Hereinafter, each component which can be contained in the ink according to the first aspect will be described.

### Black Pigment

The ink according to the first aspect contains at least one kind of a black pigment.

The black pigment contributes to the average attenuation coefficient k of the coating film being 0.10 or more.

In the black pigment, the average refractive index n in the wavelength range of 400 nm to 700 nm is preferably 2.00 or more.

As a result, it is easy to achieve that the average refractive index n of the coating film is 1.60 or more.

In the black pigment, the average attenuation coefficient k in the wavelength range of 400 nm to 700 nm is preferably 0.10 or more.

As a result, it is easy to achieve that the average attenuation coefficient k of the coating film is 0.10 or more.

The black pigment preferably includes at least one selected from the group consisting of carbon black and titanium carbide.

As a result, it is easy to achieve that the average attenuation coefficient k of the coating film is 0.10 or more.

In a case where the black pigment includes at least one selected from the group consisting of carbon black and titanium carbide, a total proportion of the carbon black and the titanium carbide in the black pigment is preferably 50% by mass or more, more preferably 60% by mass or more, and still more preferably 80% by mass or more.

Regarding the carbon black as the black pigment, known carbon blacks described in known documents such as JP2013-047311A, JP2013-047312A, and JP2013-185135A can be used.

Regarding the titanium carbide as the black pigment, known titanium carbide described in known documents such as JP2019-151786A and JP2016-122101A can be used.

The black pigment preferably includes carbon black.

As a result, it is easy to achieve that the average attenuation coefficient k of the coating film is 0.10 or more.

In a case where the black pigment includes the carbon black, a proportion of the carbon black in the black pigment is preferably 50% by mass or more, more preferably 60% by mass or more, and still more preferably 80% by mass or more.

A content of the black pigment in the ink according to the first aspect is preferably 3.0% by mass to 20.0% by mass, more preferably 4.0% by mass to 16.0% by mass, and still more preferably 5.0% by mass to 10.0% by mass with respect to the total amount of the ink.

In the ink according to the first aspect, a proportion of the black pigment with respect to the total of the black pigment, the colored pigment, and the colorless pigment is preferably 10% by mass to 90% by mass, more preferably 20% by mass to 90% by mass, still more preferably 30% by mass to 90% by mass, and even more preferably 40% by volume to 90% by volume.

Pigment Other than Black Pigment (Colored Pigment and Colorless Pigment)

The ink according to the first aspect contains at least one of the colored pigment or the colorless pigment (hereinafter, also referred to as “pigment other than the black pigment”).

The pigment other than the black pigment contributes to improvement of the inner surface reflection suppression property of the coating film (specifically, to set the average attenuation coefficient k of the coating film to be 0.15 or less).

In each of the colored pigment and the colorless pigment, the average refractive index n in the wavelength range of 400 nm to 700 nm is preferably 2.00 or more.

As a result, it is easy to achieve that the average refractive index n of the coating film is 1.60 or more.

In the colored pigment, the average attenuation coefficient k in the wavelength range of 400 nm to 700 nm is preferably 0.10 or more.

As a result, it is easy to achieve that the average attenuation coefficient k of the coating film is 0.10 or more.

The colored pigment preferably includes at least one selected from the group consisting of iron oxide (III), silicon carbide, and copper oxide (I).

In a case where the colored pigment includes at least one selected from the group consisting of iron oxide (III), silicon carbide, and copper oxide (I), the total proportion of the iron oxide (III), the silicon carbide, and the copper oxide (I) in the colored pigment is preferably 50% by mass or more, more preferably 60% by mass or more, and still more preferably 80% by mass or more.

Regarding the colored pigment, known documents such as JP2016-37565A, JP2017-160425A, and JP2016-160124A can be appropriately referred to.

The colorless pigment preferably includes at least one selected from the group consisting of titanium oxide, diamond, zirconia, and indium tin oxide.

In a case where the colorless pigment includes at least one selected from the group consisting of titanium oxide, diamond, zirconia, and indium tin oxide, the total proportion of the titanium oxide, the diamond, the zirconia, and the indium tin oxide in the colorless pigment is preferably 50% by mass or more, more preferably 60% by mass or more, and still more preferably 80% by mass or more.

Regarding the colorless pigment, known documents such as JP2022-182031A and JP2023-104069A can be appropriately referred to.

From the viewpoint of tint (preferably black and more preferably jet black) of the coating film, the pigment other than the black pigment preferably includes the colorless pigment.

In this case, a proportion of the colorless pigment in the pigment other than the black pigment is preferably 50% by mass or more, more preferably 60% by mass or more, and still more preferably 80% by mass or more.

A content of the pigment other than the black pigment in the ink according to the first aspect is preferably 1.0% by mass to 25.0% by mass, more preferably 1.0% by mass to 10.0% by mass, and still more preferably 1.5% by mass to 10.0% by mass with respect to the total amount of the ink.

### Total Mass Ratio of Black Pigment, Colored Pigment, and Colorless Pigment

The total mass ratio of the black pigment, the colored pigment, and the colorless pigment in the total solid content of the ink according to the first aspect is preferably 6.5% by mass to 25.8% by mass, more preferably 7.0% by mass to 25.0% by mass, and still more preferably 8.0% by mass to 20.0% by mass.

Here, the total solid content means all components excluding the volatile component.

### Median Diameter of Pigments

In the ink according to the first aspect, a median diameter (D50) of the pigments is preferably 100 nm or less.

In the present disclosure, the median diameter (D50) of the pigments means a median diameter of all pigments contained in the ink (the black pigment, the colored pigment, and the colorless pigment).

In the present disclosure, the median diameter (D50) of the pigments is obtained by the following method.

20 μL of the ink to be measured is diluted with 780 μL of propyl acetate to prepare a diluent for measuring the median diameter. A frequency of scattering intensity distribution of the obtained diluent is measured using a multi-sample nanoparticle size measurement system nanoSAQLA manufactured by Otsuka Electronics at a measurement temperature of 20° C., and the median diameter (D50) is obtained based on the obtained frequency of scattering intensity distribution

The median diameter (D50) of the pigment sis more preferably 70 nm or less, and still more preferably 50 nm or less.

The lower limit of the median diameter (D50) of the pigments is, for example, 10 nm.

### Binder

The ink according to the first aspect contains at least one kind of a binder.

The binder contributes to film-forming properties in a case of forming an ink coating film, and thus contributes to the film quality of the ink coating film.

As the binder, a known resin can be used.

The binder is preferably an epoxy resin, more preferably a fluorene-based epoxy resin or a bisphenol A-type epoxy resin, and still more preferably a fluorene-based epoxy resin.

A content of the binder (for example, the epoxy resin) in the ink according to the first aspect is preferably 0.3% by mass to 40% by mass, more preferably 10% by mass to 35% by mass, and still more preferably 10% by mass to 30% by mass with respect to the total amount of the ink.

The binder preferably includes at least one resin having an average refractive index n in the wavelength range of 400 nm to 700 nm of 1.50 or more.

As a result, it is easy to achieve that the average refractive index n of the coating film is 1.60 or more.

The binder more preferably includes at least one epoxy resin having an average refractive index n in the wavelength range of 400 nm to 700 nm of 1.60 or more (hereinafter, also referred to as “epoxy resin A”).

As a result, it is easy to achieve that the average refractive index n of the coating film is 1.60 or more.

A proportion of the epoxy resin A in the binder is preferably 50% by mass or more, more preferably 60% by mass or more, and still more preferably 80% by mass or more.

The epoxy resin A preferably includes a fluorene-based epoxy resin.

The epoxy resin A preferably includes a thermosetting type epoxy resin, and more preferably includes a fluorene-based epoxy resin which is the thermosetting type epoxy resin.

In a case where the ink according to the first aspect contains the epoxy resin (for example, the epoxy resin A), it is preferable that the ink according to the first aspect further contains a thiol-based curing agent as a curing agent for the epoxy resin; and it is more preferable that the ink according to the first aspect further contains a thiol-based curing agent as a curing agent for the epoxy resin and a tertiary amine as a curing accelerator.

In a case where the ink according to the first aspect contains the thiol-based curing agent as a curing agent for the epoxy resin, the film-forming properties in a case of forming an ink coating film (particularly, film-forming properties in a case of heating under relatively low-temperature conditions such as 70° C. or lower) is more excellent.

Examples of the thiol-based curing agent include jER CURE QX40 manufactured by Mitsubishi Chemical Corporation.

Regarding the thiol-based curing agent, known documents such as JP2019-210325A and JP2016-75845A can be appropriately referred to.

A content of the thiol-based curing agent is preferably 0.2% by mass to 20.0% by mass, more preferably 1.0% by mass to 20.0% by mass, still more preferably 2.0% by mass to 20.0% by mass, and even more preferably 5.0% by mass to 20.0% by mass with respect to the total amount of the ink.

Examples of the tertiary amine as a curing accelerator include DMP-30 (2,4,6-tris(dimethylaminomethyl)phenol) manufactured by FUJIFILM Wako Pure Chemical Corporation.

Regarding the tertiary amine as the curing accelerator, known documents such as JP2015-67832A and JP2021-187910A can be appropriately referred to.

A content of the tertiary amine as the curing accelerator is preferably 0.1% by mass to 10.0% by mass and more preferably 1.0% by mass to 5.0% by mass with respect to the total amount of the ink.

### Volatile Component

The ink according to the first aspect contains at least one kind of a volatile component.

A content of the volatile component is preferably 50% by mass or more, more preferably 55% by mass or more, and still more preferably 60% by mass or more with respect to the total amount of the ink.

The volatile component preferably includes an organic solvent, and more preferably includes an organic solvent having a boiling point of 180° C. or lower.

In a case where the volatile component includes the organic solvent having a boiling point of 180° C. or lower, the film-forming properties in a case of forming an ink coating film (particularly, film-forming properties in a case of heating under relatively low-temperature conditions such as 70° C. or lower) is more excellent.

A proportion of the organic solvent having a boiling point of 180° C. or lower in the organic solvent as a volatile component is preferably 50% by mass or more, more preferably 60% by mass or more, and still more preferably 80% by mass or more.

In the present disclosure, the “boiling point” means a boiling point at atmospheric pressure.

The volatile component preferably includes at least one selected from the group consisting of propyl acetate, propylene glycol methyl ether acetate, propylene glycol monomethyl ether acetate, propylene glycol monomethyl ether, toluene, cyclohexane, and ethylene glycol monobutyl ether.

All of these organic solvents are organic solvents having a boiling point of 180° C. or lower.

In addition to the above-described examples, examples of the organic solvent having a boiling point of 180° C. or lower include ethanol, isopropyl alcohol, ethyl acetate, isobutyl acetate, butyl acetate, methyl ethyl ketone, methyl isobutyl ketone, xylene, acetone, ethyl cellosolve, ether, hexane, 1-butanol, methylcyclohexane, ethylcyclohexane, isohexane, butyl cellosolve, 1-butoxy-2-propanol, trichloroethylene, perchloroethylene, methanol, cellosolve acetate, mineral spirit, tetrahydrofuran, dioxane, and ethyl lactate.

The ink according to the first aspect may contain an organic solvent having a boiling point of higher than 180° C.

Examples of the organic solvent having a boiling point of higher than 180° C. include γ-butyrolactone and diethylene glycol diethyl ether.

### Silane Coupling Agent

The ink according to the first aspect may contain at least one kind of a silane coupling agent.

In a case where the ink according to the first aspect contains the silane coupling agent, adhesiveness to the optical member, hardness, and solvent resistance of a coating film formed using the ink are further improved.

The silane coupling agent is preferably a silane compound including “functional group A”, which is at least one selected from the group consisting of an epoxy group, an amino group, a mercapto group, and an isocyanate group.

In a case where the silane coupling agent includes the functional group A, the binding ability to the binder is more excellent.

From the viewpoint of the binding ability to the optical member, the silane coupling agent including the functional group A may further includes an alkoxy group (preferably, a methoxy group or an ethoxy group).

Specific examples of the silane coupling agent include:
2-(3,4-epoxycyclohexyl) ethyltrimethoxysilane,
3-glycidoxypropyl trimethoxysilane,
3-glycidoxypropyl methyldimethoxysilane,
3-glycidoxypropyl methyldiethoxysilane,
3-glycidoxypropyl triethoxysilane,
8-glycidoxyoctyl trimethoxysilane,
3-aminopropyl trimethoxysilane,
3-aminopropyl triethoxysilane,
aminoethyl aminopropyl trimethoxysilane,
3-aminoethyl aminopropyl trimethoxysilane,
3-isocyanatopropyl triethoxysilane,
3-mercaptopropyl trimethoxysilane, and
3-mercaptopropyl methyldimethoxysilane.

Specific examples of the silane coupling agent other than the above specific examples include an organosilane having the functional group A.

Commercially available products can be used as the silane coupling agent.

Examples of the commercially available product of 2-(3,4-epoxycyclohexyl) ethyltrimethoxysilane include KBM-303 manufactured by Shin-Etsu Chemical Co., Ltd. and DOWSIL (registered trade name) Z-6043 Silane manufactured by Dow Corning Toray Co., Ltd.

Examples of the commercially available product of 3-glycidoxypropyl trimethoxysilane include KBM-403 manufactured by Shin-Etsu Chemical Co., Ltd. and DOWSIL (registered trade name) Z-6040 Silane manufactured by Dow Corning Toray Co., Ltd.

Examples of the commercially available product of 3-glycidoxypropyl methyldimethoxysilane include KBM-402 manufactured by Shin-Etsu Chemical Co., Ltd.

Examples of the commercially available product of 3-glycidoxypropyl methyldiethoxysilane include KBE-402 manufactured by Shin-Etsu Chemical Co., Ltd.

Examples of the commercially available product of 3-glycidoxypropyl triethoxysilane include KBE-403 manufactured by Shin-Etsu Chemical Co., Ltd.

Examples of the commercially available product of 8-glycidoxyoctyl trimethoxysilane include KBM-4803 manufactured by Shin-Etsu Chemical Co., Ltd.

Examples of the commercially available product of the organosilane (other than the above specific examples) having an epoxy group as the functional group A include X-12-981S manufactured by Shin-Etsu Chemical Co., Ltd. and X-12-984S manufactured by Shin-Etsu Chemical Co., Ltd.

Examples of the commercially available product of 3-aminopropyl trimethoxysilane include KBM-903 manufactured by Shin-Etsu Chemical Co., Ltd.

Examples of the commercially available product of 3-aminopropyl triethoxysilane include KBE-903 manufactured by Shin-Etsu Chemical Co., Ltd. and DOWSIL (registered trade name) Z-6011 Silane manufactured by Dow Corning Toray Co., Ltd.

Examples of the commercially available product of aminoethyl aminopropyl trimethoxysilane include DOWSIL (registered trade name) Z-6062 Silane manufactured by Dow Corning Toray Co., Ltd.

Examples of the commercially available product of 3-aminoethyl aminopropyl trimethoxysilane include DOWSIL (registered trade name) Z-6094 Silane manufactured by Dow Corning Toray Co., Ltd.

Examples of the commercially available product of the organosilane (other than the above specific examples) having an amino group as the functional group A include X-12-972F manufactured by Shin-Etsu Chemical Co., Ltd. and X-12-984S manufactured by Shin-Etsu Chemical Co., Ltd.

Examples of the commercially available product of 3-isocyanatopropyl triethoxysilane include KBE-9007 manufactured by Shin-Etsu Chemical Co., Ltd.

Examples of the commercially available product of the organosilane (other than the above specific examples) having an isocyanate group as the functional group A include X-12-1159L manufactured by Shin-Etsu Chemical Co., Ltd.

Examples of the commercially available product of 3-mercaptopropyl trimethoxysilane include KBM-803 manufactured by Shin-Etsu Chemical Co., Ltd. and DOWSIL (registered trade name) Z-6062 Silane manufactured by Dow Corning Toray Co., Ltd.

Examples of the commercially available product of 3-mercaptopropyl methyldimethoxysilane include KBM-802 manufactured by Shin-Etsu Chemical Co., Ltd.

Examples of the commercially available product of the organosilane (other than the above specific examples) having a mercapto group as the functional group A include X-12-1154 manufactured by Shin-Etsu Chemical Co., Ltd. and X-12-1156 manufactured by Shin-Etsu Chemical Co., Ltd.

In a case where the ink according to the first aspect contains the silane coupling agent, a content of the silane coupling agent is preferably 1% by mass to 50% by mass, more preferably 5% by mass to 30% by mass, and still more preferably 10% by mass to 25% by mass with respect to the total amount of the binder in the ink according to the first aspect.

In a case where the content of the silane coupling agent is 1% by mass or more, the adhesiveness to the optical member, hardness, and solvent resistance of the coating film formed using the ink are more excellent.

In a case where the content of the silane coupling agent is 50% by mass or less, the light shielding properties and the refractive index of the coating film formed using the ink are more excellent.

### Filler

The ink according to the first aspect may contain at least one kind of a filler.

In a case where the ink according to the first aspect contains the filler, the gloss of the coating film formed using the ink is more suppressed.

The material for the filler may be an inorganic material, an organic material, or an inorganic-organic composite material.

The filler may include two or more materials.

Examples of the filler include mica, a silicone resin particle, a silicone rubber particle, a silicone resin/silicone rubber composite particle, a urethane resin particle, an acrylic resin particle, and a urethane resin/acrylic resin composite particle.

Examples of the filler include a particle having an average primary particle diameter of 1 μm to 30 μm (preferably, 2 μm to 30 μm).

The shape of the filler may be any shape such as spherical or thin scale-like shape.

In a case where the filler has a shape other than a spherical shape, the particle diameter of the filler means the equivalent circle diameter of the filler.

The commercially available product can be used as the filler.

Examples of the commercially available product of mica as the filler include:
mica powder A-11 (product name, average primary particle diameter of 3 μm, thin scale-like shape) manufactured by YAMAGUCHI MICA CO., LTD.,
mica powder SJ-005 (product name, average primary particle diameter of 5 μm, thin scale-like shape) manufactured by YAMAGUCHI MICA CO., LTD.,
mica powder TM-10 (product name, average primary particle diameter of 11 μm, thin scale-like shape) manufactured by YAMAGUCHI MICA CO., LTD.,
mica powder A-21S (product name, average primary particle diameter of 22 μm, thin scale-like shape) manufactured by YAMAGUCHI MICA CO., LTD., and
mica powder SYA-21R (product name, average primary particle diameter of 27 μm, thin scale-like shape) manufactured by YAMAGUCHI MICA CO., LTD.

Examples of the commercially available product of the silicone resin particle as the filler include:
silicone resin powder TOSPEARL 120 (product name, average primary particle diameter of 2 μm, spherical shape) manufactured by Momentive Performance Materials Inc.,
silicone resin powder KPM-590 (product name, average primary particle diameter of 2 μm, spherical shape) manufactured by Shin-Etsu Chemical Co., Ltd.,
silicone resin powder X-52-1620 (product name, average primary particle diameter of 5 μm, spherical shape) manufactured by Shin-Etsu Chemical Co., Ltd.,
silicone resin powder TOSPEARL 2000B (product name, average primary particle diameter of 6 μm, spherical shape) manufactured by Momentive Performance Materials Inc., and
silicone resin powder TOSPEARL 1110 (product name, average primary particle diameter of 11 μm, spherical shape) manufactured by Momentive Performance Materials Inc.

Examples of the commercially available product of the silicone rubber particle as the filler include:
silicone rubber powder KMP-597 (product name, average primary particle diameter of 5 μm, spherical shape) manufactured by Shin-Etsu Chemical Co., Ltd.,
silicone rubber powder KMP-598 (product name, average primary particle diameter of 13 μm, spherical shape) manufactured by Shin-Etsu Chemical Co., Ltd., and
silicone rubber powder KMP-402 (product name, average primary particle diameter of 30 μm, spherical shape) manufactured by Shin-Etsu Chemical Co., Ltd.

Examples of the commercially available product of the silicone resin/silicone rubber composite particle as the filler include:
silicone resin/silicone rubber composite powder KMP-605 (product name, average primary particle diameter of 2 μm, spherical shape) manufactured by Shin-Etsu Chemical Co., Ltd.,
silicone resin/silicone rubber composite powder KMP-600 (product name, average primary particle diameter of 5 μm, spherical shape) manufactured by Shin-Etsu Chemical Co., Ltd.,
silicone resin/silicone rubber composite powder KMP-601 (product name, average primary particle diameter of 12 μm, spherical shape) manufactured by Shin-Etsu Chemical Co., Ltd., and
silicone resin/silicone rubber composite powder KMP-602 (product name, average primary particle diameter of 30 μm, spherical shape) manufactured by Shin-Etsu Chemical Co., Ltd.

Examples of the commercially available product of the urethane resin particle as the filler include:
urethane resin particle U-600T (product name, average primary particle diameter of 10 μm, spherical shape) manufactured by Negami Chemical Industrial Co., Ltd.

Examples of the commercially available product of the acrylic resin particle as the filler include:
acrylic resin particle G-800BK (product name, average primary particle diameter of 6 μm, spherical shape) manufactured by Negami Chemical Industrial Co., Ltd., and
acrylic resin particle G-400BK (product name, average primary particle diameter of 15 μm, spherical shape) manufactured by Negami Chemical Industrial Co., Ltd.

Examples of the commercially available product of the urethane resin/acrylic resin composite particle as the filler include:
urethane resin/acrylic resin composite particle TE-812T (product name, average primary particle diameter of 6 μm, spherical shape) manufactured by Negami Chemical Industrial Co., Ltd.

In a case where the ink according to the first aspect contains the filler, a content of the filler is preferably 1% by mass to 40% by mass, more preferably 2% by mass to 30% by mass, and still more preferably 5% by mass to 20% by mass with respect to the total amount of the binder in the ink according to the first aspect.

In a case where the content of the filler is 1% by mass or more, the gloss of the coating film formed using the ink is more suppressed.

In a case where the content of the filler is 40% by mass or less, the tint of the coating film is more excellent (for example, the amount of the white spot in the coating film can be suppressed).

### Other Components

The ink according to the first aspect may contain other components in addition to the above-described components.

Regarding the other components which can be contained, the disclosure in JP1982-8264A (JP-S57-8264A), JP2012-149197A, and the like can be appropriately referred to.

### Ink According to Second Aspect

The ink according to the second aspect contains a black pigment, at least one of a colored pigment or a colorless pigment, a binder, and a volatile component, in which, with regard to each of the black pigment, the colored pigment, and the colorless pigment, an average refractive index n in a wavelength range of 400 nm to 700 nm is 2.00 or more, with regard to each of the black pigment and the colored pigment, an average attenuation coefficient k is 0.10 or more, and a total mass ratio of the black pigment, the colored pigment, and the colorless pigment in a total solid content is 6.5% by mass to 25.8% by mass.

Here, the total solid content means all components excluding the volatile component.

With the ink according to the second aspect, it is possible to form a coating film of an optical member, having excellent light shielding properties, excellent inner surface reflection suppression property, excellent refractive index, and excellent film quality.

The effect of the light shielding properties is an effect obtained by the fact that the total ratio of the black pigment, the colored pigment, and the colorless pigment in the total solid content is 6.5% by mass or more and the average attenuation coefficient k of each of the black pigment and the colored pigment is 0.10 or more.

The effect of the inner surface reflection suppression property is an effect obtained by the fact that the average refractive index n is 1.60 or more and the ink contains at least one of the colored pigment or the colorless pigment.

The effect of the refractive index is an effect obtained by the fact that the average refractive index n of each of the black pigment, the colored pigment, and the colorless pigment in the wavelength range of 400 nm to 700 nm is 2.00 or more.

The effect of the film quality is obtained by the fact that the total ratio of the black pigment, the colored pigment, and the colorless pigment in the total solid content is 25.8% by mass or less.

Preferred aspects of the ink according to the second aspect other than the above-described features are the same as the preferred aspects of the ink according to the first aspect.

### Coating Film of Optical Member

The coating film of an optical member according to the present disclosure is a coating film of an optical member, containing a black pigment and at least one of a colored pigment or a colorless pigment, in which an average refractive index n of the coating film of an optical member in a wavelength range of 400 nm to 700 nm is 1.70 or more, and an average attenuation coefficient k of the coating film of an optical member in the wavelength range of 400 nm to 700 nm is 0.10 to 0.15, and a total ratio of the black pigment, the colored pigment, and the colorless pigment in an entire volume of the coating film of an optical member is 10% by volume to 40% by volume.

With the coating film of an optical member according to the present disclosure, the same effects as those of the ink according to the first aspect described above can be obtained.

Preferred aspects of the coating film of an optical member according to the present disclosure are as described in the section of “Ink for Forming Coating Film of Optical Member”.

### Optical Member

The optical member according to the present disclosure is an optical member including a base material of an optical member, and a coating film of an optical member, provided on a part (for example, an outer peripheral surface) of the base material of an optical member, in which the coating film of an optical member contains a black pigment and at least one of a colored pigment or a colorless pigment, an average refractive index n of the coating film of an optical member in a wavelength range of 400 nm to 700 nm is 1.70 or more, and an average attenuation coefficient k of the coating film of an optical member in the wavelength range of 400 nm to 700 nm is 0.10 to 0.15, and a total ratio of the black pigment, the colored pigment, and the colorless pigment in an entire volume of the coating film of an optical member is 10% by volume to 40% by volume.

With the optical member according to the present disclosure, the same effects as those of the ink according to the first aspect described above can be obtained.

Preferred aspects of the coating film of an optical member in the optical member according to the present disclosure are as described in the section of the ink according to the first aspect.

Examples of the base material of an optical member include a glass base material and a plastic base material.

A method for measuring the average refractive index n and a preferred range of the base material of an optical member in the wavelength range of 400 nm to 700 nm are the same as the method for measuring the average refractive index n and the preferred range of the coating film of an optical member in the wavelength range of 400 nm to 700 nm, which are as described in the section of the ink according to the first aspect.

From the viewpoint of further improving the inner surface reflection suppression property by the coating film of an optical member, an absolute value of a difference between the average refractive index n of the base material of an optical member and the average refractive index n of the coating film of an optical member is preferably 0.2 or less and more preferably 0.1 or less.

An outer diameter of the base material of an optical member is, for example, 1 mm to 300 mm, preferably 3 mm to 220 mm and more preferably 10 mm to 150 mm.

A thickness of the base material of an optical member is, for example, 0.5 mm to 30 mm, preferably 1 mm to 20 mm and more preferably 2 mm to 15 mm.

Examples of the optical member according to the present disclosure include a lens, a prism, and a waveguide.

Examples of the base material of an optical member in the optical member according to the present disclosure include a base material for a lens, a base material for a prism, and a base material for a waveguide.

More specific examples of the optical member according to the present disclosure include an optical member for broadcasting, an optical member for cinema, an optical member for a digital camera, an optical member for an industrial camera, an optical member for a projector, an optical member for a vehicle-mounted camera, an optical member for a smartphone-mounted camera, an optical member using a prism (for example, binoculars, periscopes, and the like), and an optical member using an optical waveguide (for example, smart glasses and the like).

### EXAMPLES

Hereinafter, examples of the present disclosure will be shown, but the present disclosure is not limited to the following examples.

### Examples 1 to 29 and Comparative Examples 1 to 4

### Preparation of Ink

An ink containing the respective components shown in Tables 1 to 3 was prepared.

Specifically, the following components were used.

### Black Pigment

Carbon black . . . HCF #2650 manufactured by Mitsubishi Chemical Corporation
Titanium carbide . . . NP-TIC-2-100 manufactured by EM Japan Co., LTD.

### Colored Pigment

Iron oxide (III) . . . iron oxide (III) nanoparticles manufactured by RMML Co., Ltd.
Silicon carbide . . . NP-SIC-9-100 manufactured by EM Japan Co., LTD.
Copper oxide (I) . . . copper oxide (I) nanoparticles manufactured by RMML Co., Ltd.

### Colorless Pigment

Titanium oxide . . . TTO-55 (B) manufactured by ISHIHARA SANGYO KAISHA, LTD.
Diamond . . . N1083 manufactured by TOKYO CHEMICAL INDUSTRY CO., LTD.
Zirconia: Zirconeo-Cp manufactured by Aitec.
ITO . . . Indium Tin Oxide, E-ITO manufactured by Mitsubishi Materials Electronic Chemicals Co., Ltd.

### Binder

Fluorene-based epoxy resin . . . CG-500 manufactured by Osaka Gas Chemicals Co., Ltd.
Bisphenol A-type epoxy resin . . . jER828 manufactured by Mitsubishi Chemical Corporation

### Curing Agent

Thiol-based curing agent . . . jER CURE QX40 manufactured by Mitsubishi Chemical Corporation
Modified amine-based curing agent . . . Fujicure 7005 manufactured by T&K TOKA

### Corporation

### Curing Accelerator

Tertiary amine . . . 2,4,6-tris (dimethylaminomethyl) phenol, DMP-30 manufactured by FUJIFILM Wako Pure Chemical Corporation

### Dispersant

SOLSPERSE 39000 manufactured by Lubrizol Corporation

### Organic Solvent

Propyl acetate . . . manufactured by FUJIFILM Wako Pure Chemical Corporation
PGMEA . . . propylene glycol monomethyl ether acetate, manufactured by FUJIFILM Wako Pure Chemical Corporation
PGME . . . propylene glycol monomethyl ether, manufactured by TOKYO CHEMICAL INDUSTRY CO., LTD.
Toluene . . . manufactured by FUJIFILM Wako Pure Chemical Corporation
Cyclohexane . . . manufactured by FUJIFILM Wako Pure Chemical Corporation
EGMBE . . . ethylene glycol monobutyl ether, manufactured by TOKYO CHEMICAL INDUSTRY CO., LTD.
DEGDEE . . . diethylene glycol diethyl ether, manufactured by FUJIFILM Wako Pure Chemical Corporation
γ-Butyrolactone . . . manufactured by FUJIFILM Wako Pure Chemical Corporation

The refractive index n and the attenuation coefficient k of each pigment, the refractive index n of each binder, and the boiling point (bp) of each organic solvent are as shown in Tables 1 to 3.

Here, the refractive index n and the attenuation coefficient k are an average refractive index and an average attenuation coefficient in a wavelength range of 400 nm to 700 nm, respectively.

In addition, the boiling point (bp) of each organic solvent is a boiling point (° C.) at atmospheric pressure.

### Formation of Coating Film

The above-described ink was applied onto one surface of a glass substrate (B-270 manufactured by SCHOTT, thickness: 2 mm) for evaluation. The ink was cured by heating the glass substrate on which the ink had been applied in a constant-temperature tank to obtain a coating film.

### Calculation of Volume Proportion of all Pigments in Entire Volume of Coating Film

A coating film was formed using the ink under the conditions of a coating amount of 0.02 g/m², heating and drying conditions of 70° C.×2 hours, and a film thickness of 20 μm.

Based on the obtained entire volume of the coating film and the density of each pigment, a volume proportion (% by volume) of all pigments in the entire volume of the coating film, a volume proportion (% by volume) of the black pigment in the entire volume of the coating film, and a volume proportion (% by volume) of the pigment other than the black pigment (that is, the colored pigment and the colorless pigment) in the entire volume of the coating film were calculated.

The results thereof are shown in Tables 1 to 3.

Measurement of Average Refractive Index n and Average Attenuation Coefficient k of Coating Film in Wavelength Range of 400 nm to 700 nm

A coating film was formed using the ink under the conditions of a coating amount of 0.02 g/m², heating and drying conditions of 70° C.×2 hours, and a film thickness of 20 μm.

For the obtained coating film, an average refractive index n and an average attenuation coefficient k of the coating film in a wavelength range of 400 nm to 700 nm were measured.

These measurements were performed using a high-speed spectroscopic ellipsometer M-2000 manufactured by J.A. Woollam Japan.

### Evaluation of Tint of Coating Film

A tint of the coating film in which the average refractive index n and the average attenuation coefficient k had been measured was visually confirmed.

The results thereof are shown in Tables 1 to 3.

It is particularly preferable that the tint of the coating film was jet black.

### Evaluation of Film Quality (Adhesiveness) of Coating Film

A coating film for evaluating adhesiveness was formed using the ink under the conditions of a coating amount of 0.02 g/m², heating and drying conditions of 70° C.×2 hours, and a film thickness of 20 μm.

A cross hatch test was carried out on the coating film for evaluating adhesiveness in accordance with ISO 2409 (cross-cut method), and the adhesiveness of the coating film (that is, adhesiveness to the glass substrate) was evaluated according to the following evaluation standard. In the cross hatch test, a cut interval was set to 1 mm, and 25 square lattices having a size of 1 mm square were formed.

The results thereof are shown in Tables 1 to 3.

In the following evaluation standard, the rank of most excellent adhesiveness of the coating film is A.

### Evaluation Standard for Adhesiveness of Coating Film

A: the number of peeled lattices was 0 out of the 25 lattices.
B: the number of peeled lattices was 1 or 2 out of the 25 lattices.
C: the number of peeled lattices was 3 or more out of the 25 lattices.
D: a film was not formed because film-forming properties were insufficient, and thus the evaluation was impossible.

### Evaluation of Film Quality (Solvent Resistance) of Coating Film

A coating film for evaluating solvent resistance was formed using the ink under the conditions of a coating amount of 0.02 g/m², heating and drying conditions of 70° C.×2 hours, and a film thickness of 20 μm.

A surface of the coating film for evaluating solvent resistance was rubbed with a cotton swab infused with isopropyl alcohol, and it was visually confirmed whether or not the color of the coating film adhered to the cotton swab. The solvent resistance of the coating film was evaluated according to the following evaluation standard.

In the following evaluation standard, the rank of most excellent solvent resistance of the coating film is A.

The results thereof are shown in Tables 1 to 3.

### Evaluation Standard for Solvent Resistance of Coating Film

A: even after carrying out the rubbing operation with the cotton swab for 20 reciprocations, no adhesion of the color of the coating film to the cotton swab was confirmed.
B: even after carrying out the rubbing operation with the cotton swab for 10 reciprocations, no adhesion of the color of the coating film to the cotton swab was confirmed, but the adhesion of the color of the coating film to the cotton swab was confirmed during the rubbing operation for 11 to 20 reciprocations.
C: the adhesion of the color of the coating film to the cotton swab was confirmed during the rubbing operation with the cotton swab for 1 to 10 reciprocations.
D: a film was not formed because film-forming properties were insufficient, and thus the evaluation was impossible.

TABLE 1

| | | | Example | Example | Example | Example | Example | Example |
|---|---|---|---|---|---|---|---|---|
| | | | 1 | 2 | 3 | 4 | 5 | 6 |
| Component | Black | Carbon black | 5.4 | 5.4 | 2.9 | 5.4 | 5.4 | 5.4 |
| in ink | pigment | (n = 2.37, k = 0.93) | | | | | | |
| (% by mass) | | Titanium carbide | | | | | | |
| | | (n = 3.01, k = 2.58) | | | | | | |
| | Colored | Iron oxide [III] | | | | | | |
| | pigment | (n = 2.81, k = 0.47) | | | | | | |
| | | Silicon carbide | | | | | | |
| | | (n = 3.43, k = 0.40) | | | | | | |
| | | Copper oxide [I] | | | | | | |
| | | (n = 3.00, k = 0.32) | | | | | | |
| | Colorless | Titanium oxide (n = 2.72) | 6.2 | 1.4 | 22.8 | 6.2 | 6.2 | 6.2 |
| | pigment | Diamond (n = 2.40) | | | | | | |
| | | Zirconia (n = 2.20) | | | | | | |
| | | ITO (n = 2.00) | | | | | | |
| | Binder | Fluorene-based epoxy | 14.3 | 23.7 | 0.3 | 14.3 | 14.3 | 14.3 |
| | | resin (n = 1.70) | | | | | | |
| | | Bisphenol A-type epoxy | | | | | | |
| | | resin (n = 1.58) | | | | | | |
| | Curing | Thiol-based curing agent | 6.2 | 2.6 | 0.2 | 6.2 | 6.2 | 6.2 |
| | agent | Modified amine-based | | | | | | |
| | | curing agent | | | | | | |
| | Curing | Tertiary amine | 1.5 | 2.5 | 0.1 | 1.5 | 1.5 | 1.5 |
| | accelerator | | | | | | | |
| | Dispersant | SOLSPERSE 39000 | 6.1 | 4.5 | 10.0 | 6.1 | 6.1 | 6.1 |
| | Organic | Propyl acetate (bp: 104° C.) | 37.3 | 41.9 | 32.0 | | | |
| | solvent | PGMEA (bp: 146° C.) | 23.0 | 18.2 | 31.7 | 60.3 | | |
| | | PGME (bp: 120° C.) | | | | | 60.3 | |
| | | Toluene (bp: 111° C.) | | | | | | 60.3 |
| | | Cyclohexane (bp: 177° C.) | | | | | | |
| | | EGMBE (bp: 171° C.) | | | | | | |
| | | DEGDEE (bp: 188° C.) | | | | | | |
| | | γ-Butyrolactone (bp: | | | | | | |
| | | 204° C.) | | | | | | |

| Median diameter of pigments in ink (nm) | | 48.0 | 48.0 | 48.0 | 48.0 | 48.0 | 48.0 |
|---|---|---|---|---|---|---|---|
| Evaluation result of | Volume proportion of all | 15 | 10 | 40 | 15 | 15 | 15 |
| coating film | pigments in entire volume | | | | | | |
| | of coating film | | | | | | |
| | (% by volume) | | | | | | |
| | Volume proportion of | 10 | 9 | 9 | 10 | 10 | 10 |
| | black pigment in entire | | | | | | |
| | volume of coating film | | | | | | |
| | (% by volume) | | | | | | |
| | Volume proportion of | 5 | 1 | 31 | 5 | 5 | 5 |
| | pigment other than black | | | | | | |
| | pigment in entire volume | | | | | | |
| | of coating film | | | | | | |
| | (% by volume) | | | | | | |
| | Average refractive index n | 1.70 | 1.70 | 1.87 | 1.70 | 1.70 | 1.70 |
| | of coating film | | | | | | |
| | (λ = 400 to 700 nm) | | | | | | |
| | Average attenuation | 0.11 | 0.10 | 0.11 | 0.11 | 0.11 | 0.11 |
| | coefficient k of coating | | | | | | |
| | film | | | | | | |
| | (λ = 400 to 700 nm) | | | | | | |
| | (light shielding properties) | | | | | | |
| | Tint | Jet black | Jet black | Black) | Jet black | Jet black | Jet black |
| | | | | (paleness) | | | |
| | Film quality | A | B | C | A | A | A |
| | (adhesiveness) | | | | | | |
| | Film quality (solvent | A | B | C | A | A | A |
| | resistance) | | | | | | |

| | | | Example | Example | Example | Example | Example |
|---|---|---|---|---|---|---|---|
| | | | 7 | 8 | 9 | 10 | 11 |
| Component | Black | Carbon black | 5.4 | 5.4 | 5.4 | 5.3 | |
| in ink | pigment | (n = 2.37, k = 0.93) | | | | | |
| (% by mass) | | Titanium carbide | | | | | 11.1 |
| | | (n = 3.01, k = 2.58) | | | | | |
| | Colored | Iron oxide [III] | | | 7.4 | 1.6 | 4.9 |
| | pigment | (n = 2.81, k = 0.47) | | | | | |
| | | Silicon carbide | | | | | |
| | | (n = 3.43, k = 0.40) | | | | | |
| | | Copper oxide [I] | | | | | |
| | | (n = 3.00, k = 0.32) | | | | | |
| | Colorless | Titanium oxide (n = 2.72) | 6.2 | 6.2 | | | |
| | pigment | Diamond (n = 2.40) | | | | | |
| | | Zirconia (n = 2.20) | | | | | |
| | | ITO (n = 2.00) | | | | | |
| | Binder | Fluorene-based epoxy | 14.3 | 14.3 | 13.9 | 23.5 | 18.1 |
| | | resin (n = 1.70) | | | | | |
| | | Bisphenol A-type epoxy | | | | | |
| | | resin (n = 1.58) | | | | | |
| | Curing | Thiol-based curing agent | 6.2 | 6.2 | 6.1 | 2.6 | 7.9 |
| | agent | Modified amine-based | | | | | |
| | | curing agent | | | | | |
| | Curing | Tertiary amine | 1.5 | 1.5 | 1.4 | 2.4 | 1.9 |
| | accelerator | | | | | | |
| | Dispersant | SOLSPERSE 39000 | 6.1 | 6.1 | 6.5 | 4.4 | 4.8 |
| | Organic | Propyl acetate (bp: 104° C.) | | | 36.6 | 41.8 | 34.8 |
| | solvent | PGMEA (bp: 146° C.) | | | 22.7 | 18.3 | 16.6 |
| | | PGME (bp: 120° C.) | | | | | |
| | | Toluene (bp: 111° C.) | | | | | |
| | | Cyclohexane (bp: 177° C.) | 60.3 | | | | |
| | | EGMBE (bp: 171° C.) | | 60.3 | | | |
| | | DEGDEE (bp: 188° C.) | | | | | |
| | | γ-Butyrolactone (bp: | | | | | |
| | | 204° C.) | | | | | |

| Median diameter of pigments in ink (nm) | | 48.0 | 48.0 | 67.0 | 64.0 | 97.0 |
|---|---|---|---|---|---|---|
| Evaluation result of | Volume proportion of all | 15 | 15 | 15 | 10 | 10 |
| coating film | pigments in entire volume | | | | | |

| | | | | | |
|---|---|---|---|---|---|
| of coating film | | | | | |
| (% by volume) | | | | | |
| Volume proportion of | 10 | 10 | 10 | 9 | 7 |
| black pigment in entire | | | | | |
| volume of coating film | | | | | |
| (% by volume) | | | | | |
| Volume proportion of | 5 | 5 | 5 | 1 | 3 |
| pigment other than black | | | | | |
| pigment in entire volume | | | | | |
| of coating film | | | | | |
| (% by volume) | | | | | |
| Average refractive index n | 1.70 | 1.70 | 1.72 | 1.70 | 1.80 |
| of coating film | | | | | |
| (λ = 400 to 700 nm) | | | | | |
| Average attenuation | 0.11 | 0.11 | 0.13 | 0.10 | 0.10 |
| coefficient k of coating | | | | | |
| film | | | | | |
| (λ = 400 to 700 nm) | | | | | |
| (light shielding properties) | | | | | |
| Tint | Jet black | Jet black | Red | Black | Black |
| | | | black | | (slightly |
| | | | | | paleness) |
| Film quality | B | B | A | B | A |
| (adhesiveness) | | | | | |
| Film quality (solvent | B | B | A | B | A |
| resistance) | | | | | |

TABLE 2

| | | | Example | Example | Example | Example | Example | Example |
|---|---|---|---|---|---|---|---|---|
| | | | 12 | 13 | 14 | 15 | 16 | 17 |
| Component | Black | Carbon black | 5.3 | 5.4 | | 5.4 | 5.3 | |
| in ink | pigment | (n = 2.37, k = 0.93) | | | | | | |
| (% by mass) | | Titanium carbide | | | 13.9 | | | 10.1 |
| | | (n = 3.01, k = 2.58) | | | | | | |
| | Colored | Iron oxide [III] | | | | | | |
| | pigment | (n = 2.81, k = 0.47) | | | | | | |
| | | Silicon carbide | 4.6 | 1.1 | 3.8 | | | |
| | | (n = 3.43, k = 0.40) | | | | | | |
| | | Copper oxide [I] | | | | 8.9 | 1.9 | 5.2 |
| | | (n = 3.00, k = 0.32) | | | | | | |
| | Colorless | Titanium oxide (n = 2.72) | | | | | | |
| | pigment | Diamond (n = 2.40) | | | | | | |
| | | Zirconia (n = 2.20) | | | | | | |
| | | ITO (n = 2.00) | | | | | | |
| | Binder | Fluorene-based epoxy resin | 14.4 | 23.9 | 22.6 | 13.7 | 23.2 | 16.5 |
| | | (n = 1.70) | | | | | | |
| | | Bisphenol A-type epoxy | | | | | | |
| | | resin (n = 1.58) | | | | | | |
| | Curing | Thiol-based curing agent | 6.3 | 2.6 | 9.9 | 6.0 | 2.5 | 7.2 |
| | agent | Modified amine-based | | | | | | |
| | | curing agent | | | | | | |
| | Curing | Tertiary amine | 1.5 | 2.5 | 2.3 | 1.4 | 2.4 | 1.7 |
| | accelerator | | | | | | | |
| | Dispersant | SOLSPERSE 39000 | 5.5 | 4.5 | 5.9 | 7.0 | 4.4 | 4.3 |
| | Organic | Propyl acetate (bp: 104° C.) | 38.4 | 41.9 | 32.1 | 35.7 | 41.7 | 35.7 |
| | solvent | PGMEA (bp: 146° C.) | 24.1 | 18.0 | 9.4 | 22.0 | 18.5 | 19.2 |
| | | PGME (bp: 120° C.) | | | | | | |
| | | Toluene (bp: 111° C.) | | | | | | |
| | | Cyclohexane (bp: 177° C.) | | | | | | |
| | | EGMBE (bp: 171° C.) | | | | | | |
| | | DEGDEE (bp: 188° C.) | | | | | | |
| | | γ-Butyrolactone (bp: | | | | | | |
| | | 204° C.) | | | | | | |

| Median diameter of pigments in ink (nm) | | 68.0 | 63.0 | 95.0 | 68.0 | 69.0 | 92.0 |
|---|---|---|---|---|---|---|---|
| Evaluation result of | Volume proportion of all | 15 | 10 | 10 | 15 | 10 | 10 |
| coating film | pigments in entire volume | | | | | | |
| | of coating film | | | | | | |
| | (% by volume) | | | | | | |
| | Volume proportion of | 10 | 9 | 7 | 10 | 9 | 7 |
| | black pigment in entire | | | | | | |
| | volume of coating film | | | | | | |
| | (% by volume) | | | | | | |
| | Volume proportion of | 5 | 1 | 3 | 5 | 1 | 3 |
| | pigment other than black | | | | | | |
| | pigment in entire volume | | | | | | |
| | of coating film | | | | | | |
| | (% by volume) | | | | | | |
| | Average refractive index n | 1.74 | 1.71 | 1.81 | 1.73 | 1.71 | 1.80 |
| | of coating film | | | | | | |
| | (λ = 400 to 700 nm) | | | | | | |
| | Average attenuation | 0.12 | 0.10 | 0.10 | 0.12 | 0.10 | 0.10 |
| | coefficient k of coating | | | | | | |
| | film | | | | | | |
| | (λ = 400 to 700 nm) | | | | | | |
| | (light shielding properties) | | | | | | |
| | Tint | Green | Black | Black | Red | Black | Black |
| | | black | | (slightly | black | | (slightly |
| | | | | paleness) | | | paleness) |
| | Film quality (adhesiveness) | A | B | A | A | B | A |
| | Film quality (solvent | A | B | A | A | B | A |
| | resistance) | | | | | | |

| | | | Example | Example | Example | Example |
|---|---|---|---|---|---|---|
| | | | 18 | 19 | 20 | 21 |
| Component | Black | Carbon black | | | | |
| in ink | pigment | (n = 2.37, k = 0.93) | | | | |
| (% by mass) | | Titanium carbide | 15.2 | 11.6 | 10.5 | 14.0 |
| | | (n = 3.01, k = 2.58) | | | | |
| | Colored | Iron oxide [III] | | | | |
| | pigment | (n = 2.81, k = 0.47) | | | | |
| | | Silicon carbide | | | | |
| | | (n = 3.43, k = 0.40) | | | | |
| | | Copper oxide [I] | | | | |
| | | (n = 3.00, k = 0.32) | | | | |
| | Colorless | Titanium oxide (n = 2.72) | | | | 3.0 |
| | pigment | Diamond (n = 2.40) | 2.7 | | | |
| | | Zirconia (n = 2.20) | | 3.5 | | |
| | | ITO (n = 2.00) | | | 3.7 | |
| | Binder | Fluorene-based epoxy resin | 21.8 | 16.6 | 15.0 | 20.0 |
| | | (n = 1.70) | | | | |
| | | Bisphenol A-type epoxy | | | | |
| | | resin (n = 1.58) | | | | |
| | Curing | Thiol-based curing agent | 9.5 | 7.2 | 6.5 | 8.7 |
| | agent | Modified amine-based | | | | |
| | | curing agent | | | | |
| | Curing | Tertiary amine | 2.3 | 1.7 | 1.5 | 2.1 |
| | accelerator | | | | | |
| | Dispersant | SOLSPERSE 39000 | 5.7 | 4.3 | 3.9 | 5.2 |
| | Organic | Propyl acetate (bp: 104° C.) | 32.3 | 35.8 | 36.9 | 33.5 |
| | solvent | PGMEA (bp: 146° C.) | 10.5 | 19.3 | 21.9 | 13.6 |
| | | PGME (bp: 120° C.) | | | | |
| | | Toluene (bp: 111° C.) | | | | |
| | | Cyclohexane (bp: 177° C.) | | | | |
| | | EGMBE (bp: 171° C.) | | | | |
| | | DEGDEE (bp: 188° C.) | | | | |
| | | γ-Butyrolactone (bp: | | | | |
| | | 204° C.) | | | | |

| Median diameter of pigments in ink (nm) | | 93.0 | 99.0 | 94.0 | 97.0 |
|---|---|---|---|---|---|
| Evaluation result of | Volume proportion of all | 10 | 10 | 10 | 10 |
| coating film | pigments in entire volume | | | | |

| | | | | |
|---|---|---|---|---|
| of coating film | | | | |
| (% by volume) | | | | |
| Volume proportion of | 8 | 8 | 8 | 8 |
| black pigment in entire | | | | |
| volume of coating film | | | | |
| (% by volume) | | | | |
| Volume proportion of | 2 | 2 | 2 | 2 |
| pigment other than black | | | | |
| pigment in entire volume | | | | |
| of coating film | | | | |
| (% by volume) | | | | |
| Average refractive index n | 1.80 | 1.79 | 1.79 | 1.80 |
| of coating film | | | | |
| (λ = 400 to 700 nm) | | | | |
| Average attenuation | 0.11 | 0.11 | 0.11 | 0.11 |
| coefficient k of coating | | | | |
| film | | | | |
| (λ = 400 to 700 nm) | | | | |
| (light shielding properties) | | | | |
| Tint | Black | Black | Black | Black |
| | (slightly | (slightly | (slightly | (slightly |
| | gray) | gray) | gray) | gray) |
| Film quality (adhesiveness) | A | A | A | A |
| Film quality (solvent | A | A | A | A |
| resistance) | | | | |

TABLE 3

| | | | Example | Example | Example | Example | Example | Example | Example |
|---|---|---|---|---|---|---|---|---|---|
| | | | 22 | 23 | 24 | 25 | 26 | 27 | 28 |
| Component | Black | Carbon black | 6.3 | 7.0 | 6.9 | 7.1 | 6.9 | 5.4 | 5.4 |
| in ink | pigment | (n = 2.37, k = 0.93) | | | | | | | |
| (% by mass) | | Titanium carbide | | | | | | | |
| | | (n = 3.01, k = 2.58) | | | | | | | |
| | Colored | Iron oxide [III] | | | 2.1 | | | | |
| | pigment | (n = 2.81, k = 0.47) | | | | | | | |
| | | Silicon carbide | | | | 1.4 | | | |
| | | (n = 3.43, k = 0.40) | | | | | | | |
| | | Copper oxide [I] | | | | | 2.5 | | |
| | | (n = 3.00, k = 0.32) | | | | | | | |
| | Colorless | Titanium oxide (n = 2.72) | 7.2 | 1.8 | | | | 6.2 | 6.2 |
| | pigment | Diamond (n = 2.40) | | | | | | | |
| | | Zirconia (n = 2.20) | | | | | | | |
| | | ITO (n = 2.00) | | | | | | | |
| | Binder | Fluorene-based | | | | | | 14.3 | 14.3 |
| | | epoxy resin (n = 1.70) | | | | | | | |
| | | Bisphenol A-type | 13.7 | 20.3 | 20.0 | 20.6 | 19.8 | | |
| | | epoxy resin (n = 1.58) | | | | | | | |
| | Curing | Thiol-based curing agent | 10.5 | 15.5 | 15.3 | 15.7 | 15.1 | | 6.2 |
| | agent | Modified amine-based | | | | | | 6.2 | |
| | | curing agent | | | | | | | |
| | Curing | Tertiary amine | 1.4 | 2.1 | 2.1 | 2.1 | 2.0 | 1.5 | 1.5 |
| | accelerator | | | | | | | | |
| | Dispersant | SOLSPERSE 39000 | 7.2 | 5.8 | 5.8 | 5.9 | 5.7 | 6.1 | 6.1 |
| | Organic | Propyl acetate (bp: 104° C.) | 26.9 | 23.7 | 23.9 | 23.6 | 24.0 | 37.3 | |
| | solvent | PGMEA (bp: 146° C.) | 26.9 | 23.7 | 23.9 | 23.6 | 24.0 | 23.0 | |
| | | PGME (bp: 120° C.) | | | | | | | |
| | | Toluene (bp: 111° C.) | | | | | | | |
| | | Cyclohexane (bp: 177° C.) | | | | | | | |
| | | EGMBE (bp: 171° C.) | | | | | | | |
| | | DEGDEE (bp: 188° C.) | | | | | | | 60.3 |
| | | γ-Butyrolactone (bp: | | | | | | | |
| | | 204° C.) | | | | | | | |

| Median diameter of pigments in ink (nm) | | 48.0 | 48.0 | 65.0 | 62.0 | 59.0 | 48.0 | 48.0 |
|---|---|---|---|---|---|---|---|---|
| Evaluation result of | Volume proportion | 15 | 10 | 10 | 10 | 10 | 15 | 15 |
| coating film | of all pigments in | | | | | | | |
| | entire volume of | | | | | | | |
| | coating film | | | | | | | |
| | (% by volume) | | | | | | | |
| | Volume proportion | 10 | 9 | 9 | 9 | 9 | 10 | 10 |
| | of black pigment in | | | | | | | |
| | entire volume of | | | | | | | |
| | coating film | | | | | | | |
| | (% by volume) | | | | | | | |
| | Volume proportion | 5 | 1 | 1 | 1 | 1 | 5 | 5 |
| | of pigment other | | | | | | | |
| | than black pigment | | | | | | | |
| | in entire volume of | | | | | | | |
| | coating film | | | | | | | |
| | (% by volume) | | | | | | | |
| | Average refractive | 1.66 | 1.63 | 1.64 | 1.64 | 1.64 | 1.70 | 1.70 |
| | index n of coating | | | | | | | |
| | film | | | | | | | |
| | (% = 400 to 700 nm) | | | | | | | |
| | Average attenuation | 0.11 | 0.10 | 0.10 | 0.10 | 0.10 | 0.11 | 0.11 |
| | coefficient k of | | | | | | | |
| | coating film | | | | | | | |
| | (% = 400 to 700 nm) | | | | | | | |
| | (light shielding | | | | | | | |
| | properties) | | | | | | | |
| | Tint | Jet black | Jet black | Black | Black | Black | Jet black | Jet black |
| | Film quality | A | A | A | A | A | C | C |
| | (adhesiveness) | | | | | | | |
| | Film quality | A | A | A | A | A | C | C |
| | (solvent resistance) | | | | | | | |

| | | | Example | Comparative | Comparative | Comparative | Comparative |
|---|---|---|---|---|---|---|---|
| | | | 29 | Example 1 | Example 2 | Example 3 | Example 4 |
| Component | Black | Carbon black | 5.4 | 5.0 | 2.8 | 7.7 | |
| in ink | pigment | (n = 2.37, k = 0.93) | | | | | |
| (% by mass) | | Titanium carbide | | | | | 15.9 |
| | | (n = 3.01, k = 2.58) | | | | | |
| | Colored | Iron oxide [III] | | | | | |
| | pigment | (n = 2.81, k = 0.47) | | | | | |
| | | Silicon carbide | | | | | |
| | | (n = 3.43, k = 0.40) | | | | | |
| | | Copper oxide [I] | | | | | |
| | | (n = 3.00, k = 0.32) | | | | | |
| | Colorless | Titanium oxide (n = 2.72) | 6.2 | 1.3 | 23.2 | | |
| | pigment | Diamond (n = 2.40) | | | | | |
| | | Zirconia (n = 2.20) | | | | | |
| | | ITO (n = 2.00) | | | | | |
| | Binder | Fluorene-based | 14.3 | 25.2 | | 17.3 | 18.1 |
| | | epoxy resin (n = 1.70) | | | | | |
| | | Bisphenol A-type | | | | | |
| | | epoxy resin (n = 1.58) | | | | | |
| | Curing | Thiol-based curing agent | 6.2 | 2.7 | | 1.9 | 7.9 |
| | agent | Modified amine-based | | | | | |
| | | curing agent | | | | | |
| | Curing | Tertiary amine | 1.5 | 2.6 | | 1.8 | 1.9 |
| | accelerator | | | | | | |
| | Dispersant | SOLSPERSE 39000 | 6.1 | 4.2 | 10.1 | 5.8 | 4.8 |
| | Organic | Propyl acetate (bp: 104° C.) | | 42.1 | 32.0 | 41.4 | 34.8 |
| | solvent | PGMEA (bp: 146° C.) | | 16.9 | 31.9 | 24.2 | 16.7 |
| | | PGME (bp: 120° C.) | | | | | |
| | | Toluene (bp: 111° C.) | | | | | |
| | | Cyclohexane (bp: 177° C.) | | | | | |
| | | EGMBE (bp: 171° C.) | | | | | |
| | | DEGDEE (bp: 188° C.) | | | | | |
| | | γ-Butyrolactone (bp: | 60.3 | | | | |
| | | 204° C.) | | | | | |

| Median diameter of pigments in ink (nm) | | 48.0 | 48.0 | 48.0 | 42.0 | 97.0 |
|---|---|---|---|---|---|---|
| Evaluation result of | Volume proportion | 15 | 9 | 41 | 15 | 10 |
| coating film | of all pigments in | | | | | |

| | | | | | |
|---|---|---|---|---|---|
| entire volume of | | | | | |
| coating film | | | | | |
| (% by volume) | | | | | |
| Volume proportion | 10 | 8 | 9 | 15 | 10 |
| of black pigment in | | | | | |
| entire volume of | | | | | |
| coating film | | | | | |
| (% by volume) | | | | | |
| Volume proportion | 5 | 1 | 32 | 0 | 0 |
| of pigment other | | | | | |
| than black pigment | | | | | |
| in entire volume of | | | | | |
| coating film | | | | | |
| (% by volume) | | | | | |
| Average refractive | 1.70 | 1.70 | 1.87 | 1.70 | 1.83 |
| index n of coating | | | | | |
| film | | | | | |
| (% = 400 to 700 nm) | | | | | |
| Average attenuation | 0.11 | 0.09 | 0.11 | 0.16 | 0.16 |
| coefficient k of | | | | | |
| coating film | | | | | |
| (% = 400 to 700 nm) | | | | | |
| (light shielding | | | | | |
| properties) | | | | | |
| Tint | Jet black | Jet black | Black | Jet black | Black |
| | | | (paleness) | | (slightly |
| | | | | | gray) |
| Film quality | C | B | D | B | A |
| (adhesiveness) | | | | | |
| Film quality | C | B | D | B | A |
| ( solvent resistance) | | | | | |

As shown in Tables 1 to 3, the ink of each of Examples contained the black pigment, at least one of the colored pigment or the colorless pigment, and the binder, and in a case of forming the coating film, the average refractive index n of the coating film of an optical member in the wavelength range of 400 nm to 700 nm was 1.60 or more, the average attenuation coefficient k of the coating film was 0.10 to 0.15, and the total ratio of the black pigment, the colored pigment, and the colorless pigment in the entire volume of the coating film was 10% by volume to 40% by volume.

The coating film of each of Examples had an average refractive index n of 1.60 or more and an average attenuation coefficient k of 0.15 or less, and thus had excellent inner surface reflection suppression property (that is, performance of suppressing an inner surface reflection in the optical member) in a case of forming a coating film of an optical member having a high refractive index.

The coating film of each of Examples had an average attenuation coefficient k of 0.10 or more, and thus had excellent light shielding properties. As a result, since the coating film of an optical member could be formed with a thin film thickness, the variation in film thickness can be reduced, and as a result, the positioning accuracy of the optical member in a case of incorporating the optical member into the mirror frame can be improved.

In the coating film of each of Examples, the total ratio of the black pigment, the colored pigment, and the colorless pigment in the entire volume of the coating film was 10% by volume or more, and thus the light shielding properties were excellent (that is, it was possible to achieve the average attenuation coefficient k to be 0.10 or more; see Tables 1 to 3).

In the coating film of each of Examples, the total ratio of the black pigment, the colored pigment, and the colorless pigment in the entire volume of the coating film was 40% by volume or less, and thus the film quality (that is, adhesiveness and solvent resistance) was excellent (see Tables 1 to 3).

Contrary to the examples, the comparative examples showed the following results.

In Comparative Example 1 in which the total ratio of the black pigment, the colored pigment, and the colorless pigment in the entire volume of the coating film was less than 10% by volume, the average attenuation coefficient k was less than 0.10, and thus the light shielding properties were deteriorated.

In Comparative Example 2 in which the total ratio of the black pigment, the colored pigment, and the colorless pigment in the entire volume of the coating film was more than 40% by volume, the film quality of the coating film was insufficient (specifically, the film-forming properties were insufficient and thus the film was not formed). The reason for this is considered to be that the amount of the binder was relatively insufficient.

In Comparative Examples 3 and 4 in which the ink containing the black pigment and not containing the colored pigment and the colorless pigment was used, the average attenuation coefficient k of the coating film was more than 0.15, and thus the inner surface reflection suppression property was reduced.

Among Examples 1 to 29, in Examples 1 to 21 and 27 to 29, in which the binder included the epoxy resin having an average refractive index n of 1.60 or more, the average refractive index n of the coating film was improved to 1.70 or more.

Among Examples 1 and 27, in Example 1 in which the thiol-based curing agent was used as the curing agent for an epoxy resin, the film quality of the coating film under low-temperature (70° C. or lower) heating and drying conditions was more excellent.

Among Examples 1, 28, and 29, in Example 1 in which the volatile component included the organic solvent having a boiling point of 180° C. or lower, the film quality of the coating film under low-temperature (70° C. or lower) heating and drying conditions was more excellent.

### Examples 101 to 104

The same operations as in Example 1 (including the various evaluations) were conducted except that a silane coupling agent and a filler were added to the components of the ink at amounts shown in Table 4 and the amount of the organic solvent was adjusted to the amount shown in Table 4.

The results thereof are shown in Table 4.

As the silane coupling agent, 3-glycidoxypropyl trimethoxysilane KBM-403 (manufactured by Shin-Etsu Chemical Co., Ltd.) was used.

As the filler, silicone resin powder X-52-1621 (average primary particle diameter of 5 μm) manufactured by Shin-Etsu Chemical Co., Ltd. was used.

For a comparison purpose, the result of Example 1 described above is also shown in Table 4.

### Evaluation—2 of Coating Film

Each of the coating films obtained in Examples 101 to 104 was evaluated according to the following evaluation—2 of the coating film.

The evaluation—2 of the coating film includes evaluations of adhesiveness—2 of the coating film, solvent resistance—2 of the coating film, hardness of coating film, gloss of the coating film, and tint—2 (amount of the white spot) of the coating film.

The results thereof are shown in Table 4.

### Adhesiveness—2 of Coating Film

A coating film for evaluating adhesiveness was formed on the above-described glass substrate using the ink under the conditions of a coating amount of 0.02 g/m², heating and drying conditions of 70° C.×2 hours, and a film thickness of 20 μm.

The adhesiveness of the obtained film to the glass substrate was measured in accordance with JIS K 5600 May 7:2014 (pull-off method). Based on the obtained results, the adhesiveness—2 of the coating film was evaluated according to the following evaluation standard. Regarding the adhesiveness-2 of the coating film, the rank of most excellent is 3.

### Evaluation Standard

3: even after exposure to high-temperature and high-humidity conditions (85° C./85% RH) over 1 week, the coating film has significant adhesiveness to the glass substrate.
2: even after exposure to high-temperature and high-humidity conditions (85° C./85% RH) less than 1 week, the coating film has significant adhesiveness to the glass substrate (excluding the case of rank “3” above).
1: if the coating film is not exposed to high-temperature and high-humidity conditions (85° C./85% RH), the coating film has significant adhesiveness to the glass substrate.

### Solvent Resistance—2 of Coating Film

A coating film for evaluating solvent resistance was formed using the ink under the conditions of a coating amount of 0.02 g/m², heating and drying conditions of 70° C.×2 hours, and a film thickness of 20 μm.

The solvent resistance of the obtained film for evaluating solvent resistance was evaluated using each of the solutions of isopropyl alcohol (IPA), acetone, ethyl acetate, and methyl ethyl ketone (MEK).

Specifically, a surface of the coating film was rubbed for 10 reciprocations with a cotton swab (diameter of 2 mm) infused with each of the solutions under a load of 1 N, and it was visually confirmed whether or not the color of the coating film adhered to the cotton swab. The solvent resistance-2 of the coating film was evaluated according to the following evaluation standard. The rank of most excellent solvent resistance of the coating film-2 is 3.

### Evaluation Standard

3: no adhesion of the color of the coating film to the cotton swab was confirmed in all the cases using ethyl acetate, MEK, acetone, and IPA.
2: adhesion of the color of the coating film to the cotton swab was confirmed in the cases using ethyl acetate and MEK but no adhesion of the color of the coating film to the cotton swab was confirmed in the cases using IPA and acetone.
1: adhesion of the color of the coating film to the cotton swab was confirmed in the cases using ethyl acetate, MEK, and acetone, but no adhesion of the color of the coating film to the cotton swab was confirmed in the case using IPA.
0: adhesion of the color of the coating film to the cotton swab was confirmed in all the cases using ethyl acetate, MEK, acetone, and IPA.

### Hardness of Coating Film

A coating film for evaluating hardness was formed using the ink under the conditions of a coating amount of 0.02 g/m², heating and drying conditions of 70° C.×2 hours, and a film thickness of 20 μm.

The coating film was scratched by pressing it with a pointed-shaped member made of brass (acute angle of) 85° under a load of 4 N at a moving speed of 70 mm/s, and the width of the resulting scratch was measured. A narrower width of the scratch indicates a higher hardness of the coating film.

Based on the measurement results, the hardness of the coating film was evaluated according to the following evaluation standard. The rank of most excellent hardness of the coating film is 3.

### Evaluation Standard

3: the width of scratch was less than 35 μm.
2: the width of scratch was 35 μm or more and less than 40 μm.
1: the width of scratch was 40 μm or more and less than 45 μm.
0: the width of scratch was 45 μm or more.

### Gloss of Coating Film

A coating film for evaluating gloss was formed using the ink under the conditions of a coating amount of 0.02 g/m², heating and drying conditions of 70° C.×2 hours, and a film thickness of 20 μm.

For the obtained coating film, “specular gloss at 60 degrees Gs (60°)” was measured according to JIS Z 8741-1997 using a gloss meter IG-410 manufactured by HORIBA Advanced Techno, Co., Ltd.

A higher value of the gloss indicates more suppressed gloss. Tint-2 of (Amount of White Spot) of Coating Film

A coating film for evaluating tint-2 (amount of white spot) was formed using the ink under the conditions of a coating amount of 0.02 g/m², heating and drying conditions of 70° C. x 2 hours, and a film thickness of 20 μm.

The obtained coating film was observed through the glass substrate, and the tint-2 (specifically, the amount of the white spot) of the coating film was evaluated according to the following evaluation standard.

### Evaluation Standard

3: no white spot was observed.
2: the white spot was slightly observed.
1: the white spot was observed.
0: the white spot was significantly observed.

TABLE 4

| | | | Example | Example | Example | Example | Example |
|---|---|---|---|---|---|---|---|
| | | | 1 | 101 | 102 | 103 | 104 |
| Component | Black | Carbon black | 5.4 | 5.4 | 5.4 | 5.4 | 5.4 |
| in ink | pigment | (n = 2.37, k = 0.93) | | | | | |
| (% by mass) | | Titanium carbide | | | | | |
| | | (n = 3.01, k = 2.58) | | | | | |
| | Colored | Iron oxide [III] | | | | | |
| | pigment | (n = 2.81, k = 0.47) | | | | | |
| | | Silicon carbide | | | | | |
| | | (n = 3.43, k = 0.40) | | | | | |
| | | Copper oxide [I] | | | | | |
| | | (n = 3.00, k = 0.32) | | | | | |
| | Colorless | Titanium oxide (n = 2.72) | 6.2 | 6.2 | 6.2 | 6.2 | 6.2 |
| | pigment | Diamond (n = 2.40) | | | | | |
| | | Zirconia (n = 2.20) | | | | | |
| | | ITO (n = 2.00) | | | | | |
| | Binder | Fluorene-based epoxy resin | 14.3 | 14.3 | 14.3 | 14.3 | 14.3 |
| | | (n = 1.70) | | | | | |
| | | Bisphenol A-type epoxy | | | | | |
| | | resin (n = 1.58) | | | | | |
| | Curing | Thiol-based curing agent | 6.2 | 6.2 | 6.2 | 6.2 | 6.2 |
| | agent | Modified amine-based | | | | | |
| | | curing agent | | | | | |
| | Curing | Tertiary amine | 1.5 | 1.5 | 1.5 | 1.5 | 1.5 |
| | accelerator | | | | | | |
| | Dispersant | SOLSPERSE 39000 | 6.1 | 6.1 | 6.1 | 6.1 | 6.1 |
| | Organic | Propyl acetate (bp: 104° C.) | 37.3 | 34.6 | 35.5 | 35.1 | 33.9 |
| | solvent | PGMEA (bp: 146° C.) | 23.0 | 21.4 | 21.8 | 21.6 | 20.9 |
| | | PGME (bp: 120° C.) | | | | | |
| | | Toluene (bp: 111° C.) | | | | | |
| | | Cyclohexane (bp: 177° C.) | | | | | |
| | | EGMBE (bp: 171° C.) | | | | | |
| | | DEGDEE (bp: 188° C.) | | | | | |
| | | γ-Butyrolactone (bp: 204° C.) | | | | | |

| | | | | |
|---|---|---|---|---|
| Silane coupling agent | 2.9 | 1.6 | 2.9 | 2.9 |
| Filler | 1.4 | 1.4 | 0.7 | 2.6 |

| Median diameter of pigments in ink (nm) | | 48.0 | 48.0 | 48.0 | 48.0 | 48.0 |
|---|---|---|---|---|---|---|
| Content of silane coupling agent respect to amount of binder | | 0 | 20.4 | 11.2 | 20.4 | 20.4 |
| (% by mass) | | | | | | |
| Content of filler respect to amount of binder (% by mass) | | 0 | 9.8 | 9.8 | 4.9 | 18.2 |
| Evaluation result of | Volume proportion of all | 15 | 13 | 14 | 14 | 13 |
| coating film | pigments in entire volume of | | | | | |
| | coating film | | | | | |
| | (% by volume) | | | | | |
| | Average refractive index n of | 1.70 | 1.70 | 1.70 | 1.70 | 1.70 |
| | coating film | | | | | |
| | (λ = 400 to 700 nm) | | | | | |
| | Average attenuation | 0.11 | 0.10 | 0.11 | 0.10 | 0.10 |
| | coefficient k of coating film | | | | | |
| | (λ = 400 to 700 nm) | | | | | |
| | (light shielding properties) | | | | | |
| | Tint | Jet black | Jet black | Jet black | Jet black | Jet black |
| | Film quality (adhesiveness) | A | A | A | A | A |
| | Film quality (solvent | A | A | A | A | A |
| | resistance) | | | | | |
| Evaluation result -2 | Adhesiveness - 2 of coating | 2 | 3 | 3 | 3 | 3 |
| of coating film | film | | | | | |
| | Solvent resistance - 2 of | 1 | 3 | 1 | 3 | 3 |
| | coating film | | | | | |
| | Hardness of coating film | 0 | 3 | 1 | 3 | 3 |
| | Gloss of coating film | 124 | 31 | 31 | 56.5 | 22 |
| | (specular gloss at 60 degrees | | | | | |
| | Gs (60°)) | | | | | |
| | Tint - 2 (amount of white spot) | 3 | 3 | 3 | 3 | 3 |
| | of coating film | | | | | |

As shown in Table 4, in a case where the ink includes the silane coupling agent and the filler (Examples 101 to 104), the coating film had an average refractive index n of 1.60 or more, an average attenuation coefficient k of 0.10 to 0.15, and the volume proportion of all pigments in the entire volume of the coating film of 10% by volume to 40% by volume, similarly to a case where the ink does not include a silane coupling agent and a filler (Example 1).

It was confirmed that the coating film of each of Examples 101 to 104 has excellent light shielding properties, inner surface reflection suppression properties, refractive index, and film quality, similarly to the coating film of Example 1.

It was also confirmed that the coating film of each of Examples 101 to 104 has improved adhesiveness, solvent resistance, and hardness, as well as deteriorated gloss, as compared to the coating film of Example 1.

The entirety of the disclosures of Japanese Patent Application No. 2023-147961, filed on Sep. 12, 2023, and Japanese Patent Application No. 2024-131233, filed on Aug. 7, 2024, are incorporated into the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. An ink for forming a coating film of an optical member, comprising:
a black pigment;
at least one of a colored pigment or a colorless pigment;
a binder; and
a volatile component,
wherein, in a case of forming a coating film of an optical member, an average refractive index n of the coating film of an optical member in a wavelength range of 400 nm to 700 nm is 1.60 or more, and an average attenuation coefficient k of the coating film of an optical member in the wavelength range of 400 nm to 700 nm is 0.10 to 0.15, and
a total volume ratio of the black pigment, the colored pigment, and the colorless pigment in an entire volume of the coating film of an optical member is 10% by volume to 40% by volume.

2. The ink for forming a coating film of an optical member according to claim 1,
wherein the average refractive index n of the coating film of an optical member in the wavelength range of 400 nm to 700 nm is 1.70 to 1.85.

3. The ink for forming a coating film of an optical member according to claim 1,
wherein, with regard to each of the black pigment, the colored pigment, and the colorless pigment, the average refractive index n in the wavelength range of 400 nm to 700 nm is 2.00 or more, and
with regard to each of the black pigment and the colored pigment, the average attenuation coefficient k is 0.10 or more.

4. The ink for forming a coating film of an optical member according to claim 1,
wherein the black pigment includes at least one selected from the group consisting of carbon black and titanium carbide,
the colored pigment includes at least one selected from the group consisting of iron oxide (III), silicon carbide, and copper oxide (I), and
the colorless pigment includes at least one selected from the group consisting of titanium oxide, diamond, zirconia, and indium tin oxide.

5. The ink for forming a coating film of an optical member according to claim 1,
wherein a median diameter of the pigments is 100 nm or less.

6. The ink for forming a coating film of an optical member according to claim 1,
wherein the binder contains an epoxy resin in which the average refractive index n in the wavelength range of 400 nm to 700 nm is 1.60 or more.

7. The ink for forming a coating film of an optical member according to claim 6,
wherein the epoxy resin includes a fluorene-based epoxy resin.

8. The ink for forming a coating film of an optical member according to claim 6,
wherein the epoxy resin includes a thermosetting type epoxy resin.

9. The ink for forming a coating film of an optical member according to claim 8, further comprising:
a thiol-based curing agent as a curing agent for an epoxy resin; and
a tertiary amine as a curing accelerator.

10. The ink for forming a coating film of an optical member according to claim 1,
wherein a content of the volatile component is 50% by mass or more with respect to a total amount of the ink for forming a coating film of an optical member.

11. The ink for forming a coating film of an optical member according to claim 1,
wherein the volatile component includes an organic solvent having a boiling point of 180° C. or lower.

12. The ink for forming a coating film of an optical member according to claim 1,
wherein the volatile component includes at least one selected from the group consisting of propyl acetate, propylene glycol monomethyl ether acetate, propylene glycol monomethyl ether, toluene, cyclohexane, and ethylene glycol monobutyl ether.

13. The ink for forming a coating film of an optical member according to claim 1, further comprising a silane coupling agent.

14. The ink for forming a coating film of an optical member according to claim 1, further comprising a filler.

15. An ink for forming a coating film of an optical member, comprising:
a black pigment;
at least one of a colored pigment or a colorless pigment;
a binder; and
a volatile component,
wherein, with regard to each of the black pigment, the colored pigment, and the colorless pigment, an average refractive index n in a wavelength range of 400 nm to 700 nm is 2.00 or more,
with regard to each of the black pigment and the colored pigment, an average attenuation coefficient k is 0.10 or more, and
a total mass ratio of the black pigment, the colored pigment, and the colorless pigment in a total solid content is 6.5% by mass to 25.8% by mass.

16. The ink for forming a coating film of an optical member according to claim 15,
wherein the black pigment includes at least one selected from the group consisting of carbon black and titanium carbide,
the colored pigment includes at least one selected from the group consisting of iron oxide (III), silicon carbide, and copper oxide (I), and
the colorless pigment includes at least one selected from the group consisting of titanium oxide, diamond, zirconia, and indium tin oxide.

17. The ink for forming a coating film of an optical member according to claim 15,
wherein a median diameter of the pigments is 100 nm or less.

18. The ink for forming a coating film of an optical member according to claim 15,
wherein the binder contains an epoxy resin in which the average refractive index n in the wavelength range of 400 nm to 700 nm is 1.60 or more.

19. The ink for forming a coating film of an optical member according to claim 18,
wherein the epoxy resin includes a fluorene-based epoxy resin.

20. The ink for forming a coating film of an optical member according to claim 18,
wherein the epoxy resin includes a thermosetting type epoxy resin.

21. The ink for forming a coating film of an optical member according to claim 20, further comprising:
a thiol-based curing agent as a curing agent for an epoxy resin; and
a tertiary amine as a curing accelerator.

22. The ink for forming a coating film of an optical member according to claim 15,
wherein a content of the volatile component is 50% by mass or more with respect to a total amount of the ink for forming a coating film of an optical member.

23. The ink for forming a coating film of an optical member according to claim 15,
wherein the volatile component includes at least one selected from the group consisting of propyl acetate, propylene glycol monomethyl ether acetate, propylene glycol monomethyl ether, toluene, cyclohexane, and ethylene glycol monobutyl ether.

24. The ink for forming a coating film of an optical member according to claim 15, further comprising a silane coupling agent.

25. The ink for forming a coating film of an optical member according to claim 15, further comprising a filler.

26. An optical member comprising:
a base material of an optical member; and
a coating film of an optical member, provided on a part of the base material of an optical member,
wherein the coating film of an optical member contains a black pigment and at least one of a colored pigment or a colorless pigment,
an average refractive index n of the coating film of an optical member in a wavelength range of 400 nm to 700 nm is 1.70 or more, and an average attenuation coefficient k of the coating film of an optical member in the wavelength range of 400 nm to 700 nm is 0.10 to 0.15, and
a total ratio of the black pigment, the colored pigment, and the colorless pigment in an entire volume of the coating film of an optical member is 10% by volume to 40% by volume.

27. The optical member according to claim 26,
wherein the optical member is an optical member for broadcasting, an optical member for cinema, an optical member for a digital camera, an optical member for an industrial camera, an optical member for a projector, an optical member for a vehicle-mounted camera, an optical member for a smartphone-mounted camera, an optical member using a prism, or an optical member using an optical waveguide.
